(19) United States
(12) Patent Application Publication
(10) Pub. No.: US 2002/0046125 A1
(43) Pub. Date: Apr. 18, 2002

(54) Systems and methods for correcting supply/demand imbalances in multi-tier exchanges

(76) Inventors: Charles Speicher, Ipswich, MA (US); James Hirschman, Swampscott, MA (US)

Correspondence Address: FOLEY, HOAG & ELIOT, LLP, PATENT GROUP, ONE POST OFFICE SQUARE, BOSTON, MA, 02109, US

(21) Appl. No.: 09/817,555

(22) Filed: Mar. 26, 2001

Related U.S. Application Data
(60) Provisional application No. 60/191,992, filed on Mar. 24, 2000.

(51) Int. Cl. G06F 17/60

(52) U.S. Cl. 705/22

(57) ABSTRACT

A system and method is disclosed for identifying and matching potential parties to a transaction involving an imbalance in a demand/supply situation. Users enter transaction data in a plurality of remote terminals of the system. The remote terminals include a first subset forming a part of at least one first (private) exchange and a second subset forming a part of a second (public) exchange. The aggregate transaction data of the first exchange define a first aggregate demand/supply imbalance of the first exchange, whereas the transaction data of the second subset define a second individual demand/supply imbalance of the individual users of the second subset. A communication network, which includes a server, links the first exchanges and the second subset of remote terminals with the server. The server polls the first exchange and the second subset of remote terminals and anonymously matches the parties based on the first and second demand/supply imbalances and on business rules administered by the server, thereby reducing the imbalance in a demand/supply situation between the parties.

### CROSS-REFERENCE TO OTHER PATENT APPLICATIONS

This application claims the benefit of U.S. Provisional Patent Application No. 60/191,992, filed Mar. 24, 2000, which is incorporated in its entirety herein by reference. This application also incorporates by reference the entirety of each reference cited throughout this application.

### FIELD OF THE INVENTION

This invention relates to methods and systems for managing inventory, and more particularly, for correcting imbalances in the supply and demand among users who are located in different trading environments.

### BACKGROUND OF THE INVENTION

Manufacturers, suppliers, distributors and resellers, in particular in the Information Technology (IT) and Electronic Components (EC) industries, are currently squandering billions of dollars a year through time and cost inefficiencies across their extended supply chains. One of the problem is an inability to predict demand and supply of Contract Manufacturers, i.e., firms contracted by Original Equipment Manufacturers (OEM) to build their products, and to match existing inventory with buyers'requests as a results of bottlenecks at the sourcing partners, inflexible sales channels and other factors which can contribute to excess inventories building in the supply chains. These inefficiencies are exacerbated by the lack of industry-wide processes and data standards that could enable system-to-system automation of core supply chain processes, such as catalog management, order management, inventory management, and customer service and support. Supply chain partners still use slow and expensive manual collaboration techniques, such as phone, fax and email, to exchange the information and conduct the transactions required to support such processes. The time and cost expended on such manual techniques translates directly into lost or incorrect orders, late deliveries, high clerical and labor costs, excessive buffer and obsolete inventory costs, and ultimately, low customer loyalty and retention.

There are currently market participants who offer flexible trading solutions for posting excess and shortages of parts, for example, in the semiconductor industry. Some e-commerce companies, like FastParts, NECX and PartMiner, operate as e-Brokers and acquire excess inventory from Sellers and Buyers and actively seek bidders for such inventory. These companies operate essentially on consignment. Other companies, like Need2Buy, do not actively acquire inventory, but protect only the anonymity of seller, and not also of the buyer. Furthermore, the present trading solutions do not provide contract manufacturers and their captive sourcing partners with opportunities to post their excess inventory for sale on the spot market.

It would therefore be desirable to provide a marketplace, for example, for trading components used in the semiconductor industry, which lets the contract manufacturers and the sourcing partners post their excess inventory and shortages for selected participants of the spot market to view and bid with the option of anonymity and without having a broker take actual possession of the inventory.

### SUMMARY OF THE INVENTION

The invention is directed to a system and a method which identifies and matches potential parties to a transaction involving an imbalance in a demand/supply situation. According to one aspect of the invention, the system has a multi-tier exchange which includes a public exchange and a private exchange, wherein the public exchange is accessible to all users upon registration with an administrator and the private exchange includes selected users, such as the Contract Manufacturers and OEMs, running their own private intranet/extranet applications. The marketplace, or the aggregate buy/sell information, will be controlled at a central online location by the administrator through application programs executed on a server. Additionally, the exchanges may share information on pricing so that participants can attract their trades and to determine historical pricing for all their RFQs and excess inventory.

The invention includes a system for identifying potential parties to a transaction, utilizing a plurality of terminals enabling users to enter transaction data into the system, with a first subset of the users forming a part of at least one first exchange, with the users of each first exchange executing transactions within the first exchange to balance supply and demand within the first exchange, where a difference between the supply and demand within the first exchange defines a first aggregate supply/demand imbalance of the first exchange. There is also provided a second subset of the users different from the first subset of the users and forming a part of a second exchange, with a user of the second subset of the users having at least one of an excess supply and an excess demand to define a second individual supply/demand imbalance of the respective user. A communication network exists with a server that links with the terminals of at least one of the first exchanges and the second subset of users, with the server polling the terminals to obtain the first aggregate and second individual supply/demand imbalances. The server applies at least one business rule to match the first aggregate and second individual supply/demand imbalances while preventing the first and second subset of users from obtaining the identity of the respective other users. This system thereby identifying potential parties to a transaction.

In one embodiment, the business rule is a part number, a part type, a part count, the characteristic attributes of a party on the other side of the transaction, a customizable time period, and the internal supply/demand of the first and second exchanges. In a particular embodiment, the characteristic attributes of a party are selected from the geographic location of the party, the name of the party, the manufacturing capacity of the party and the creditworthiness of the party.

The system of the invention also includes a server with a relational database capable of providing a common view of the transaction data to the users. Encryption can be used to provide anonymity and authenticity of the users. The relational database can further include a registry of the private exchanges and the users of the second subset and may further include cross-references of components of interest to the parties. The remote terminals forming a part of the at least one first exchange can anonymously report to the server transaction data between terminals of the subset of remote terminals of the first exchange.

Another aspect of the invention is a computer program residing on a computer-readable medium for identifying and matching potential parties to a transaction according to a plurality of business rules. The computer program can comprise instructions for causing a computer to acquire from at least one first exchange having a plurality of users, the users forming a first set of users and executing transactions within the first exchange to balance supply and demand within the first exchange, a first aggregate supply/demand imbalance of the at least one first exchange, with the first aggregate supply/demand imbalance representing a difference in the supply and demand between the users within the first exchange. The computer program can also acquire from a user being part of a second set of users different from the first set of users a second individual supply/demand imbalance of the respective user of the second set of users. The computer program can then compare and attempt to match—based on certain business rules and while preventing the users from the first and second subset of users from obtaining the identity of the respective other users—the first aggregate and second individual supply/demand imbalances between the at least one first exchange and the second set of users, respectively. This program will thereby reducing an imbalance in a supply/demand between the parties.

Another aspect of the invention is a computer-implemented transaction method to generate a match between supply and demand within boundaries established by business rules. This method can include first users forming a part of at least one first exchange and providing first transaction data, the at least one first exchange forming from the first transaction data aggregate transaction data defining a first aggregate supply/demand imbalance of the at least one first exchange. Additionally, there can be second users forming a part of a second exchange, a second user providing second transaction data which define a second individual supply/demand imbalance of the respective second user. The method then compares the first and second supply/demand imbalances and—based on the business rules and while preventing the first and second users from obtaining the identity of the respective other users—matching the at least one first exchange and the second users of the second exchange based on the first and second supply/demand imbalances. This method can reduce an imbalance in a supply/demand between the at least one first exchange and the second users. In an additional embodiment, the transaction method can have business rules selected from a part number, a part type, a part count, the characteristic attributes of a party on the other side of the transaction, a customizable time period, and an internal supply/demand of the public and private exchanges. In a further embodiment, the characteristic attributes of a party are selected from the geographic location of the party, the name of the party, the manufacturing capacity of the party or the creditworthiness of the party. The transaction method can also commonly present the transaction data to the first and second users.

This invention also provides a web site for matching supply and demand between parties to a transaction, with a first subset of the parties comprising a plurality of parties and forming a part of at least one first exchange, said first exchange providing first aggregate transaction data, and at least some of the remaining parties forming a part of a second exchange, with the parties of the second exchange providing second individual transaction data. In an embodiment the web site comprises a computer with a database accessible by the computer. A web page on the web site can receive the first aggregate and second individual transaction data from the parties while a program executing on said computer for comparing the received first aggregate transaction data and the second individual transaction data and—based on the business rules residing in the database and while preventing the first and second users from obtaining the identity of the respective other users—matching the at least one first exchange and the parties of the second exchange based on the first and second supply/demand imbalances. This web site would thereby reduce an imbalance in a supply/demand between the at least one first exchange and the parties of the second exchange. In a further embodiment, the web site can have business rules selected from the part number, the part type, part count, the characteristic attributes of a party on the other side of the transaction, the customizable time periods, and the internal supply/demand of the first and second exchanges. The web site can have characteristic attributes of a party selected from the geographic location of the party, the name of the party, the manufacturing capacity of the party and the creditworthiness of the party. The web site can have a database that is a relational database which provides a common view of the data to the parties. In an embodiment, the web page is produced using an XML protocol. The web site can further include encryption means to provide anonymity and authenticity of the parties. The database may further include a registry of the first exchanges and the parties of the second exchange. A further embodiment of the invention, the relational database includes cross-references of components of interest to the parties. Additionally, the parties of the first subset of the parties report to the computer transaction data between the parties of the first subset of the parties.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 is a schematic diagram of a mixed exchange;

FIG. 2 is a schematic diagram of network connections in the multi-tier trading environment of FIG. 1;

FIG. 3 shows an exemplary user interface of the multi-tier trading environment of FIG. 1;

FIG. 4 shows schematically a demand/supply imbalance in a private exchange of FIG. 1;

FIG. 5 is a flow chart for balancing inventory in a situation with excess demand; and

FIG. 6 is s flow chart for balancing inventory in a situation with excess supply.

### DETAILED DESCRIPTION OF CERTAIN ILLUSTRATED EMBODIMENTS

To provide an overall understanding of the invention, certain illustrative embodiments will now be described. However, it will be understood by one of ordinary skill in the art that the systems and methods described herein can be adapted and modified for other suitable applications and that such other additions and modifications will not depart from the scope hereof.

The invention is directed to balancing a supply/demand situation in a multi-tier trading environment which includes private exchanges having selected sourcing partners that the private exchange can manage and control, and with public exchanges which are not part of the public exchange, but are registered with an administrator of the multi-tier trading environment. The administrator is able to monitor both the public exchanges and the private exchanges and can reduce the imbalance in the demand/supply situation between parties by facilitating anonymous trading between the parties. Anonymous trading refers to an environment where neither the buyer's nor the seller's identity is revealed to the other parties participating in the trading. However, the identity of the parties is known to the administrator who sets business rules for the transactions. The business rules control the flow and assist in decision-making, as will be discussed below. Control over or possession of the traded inventory, until a deal is struck between the anonymously trading parties, remains with the trading parties.

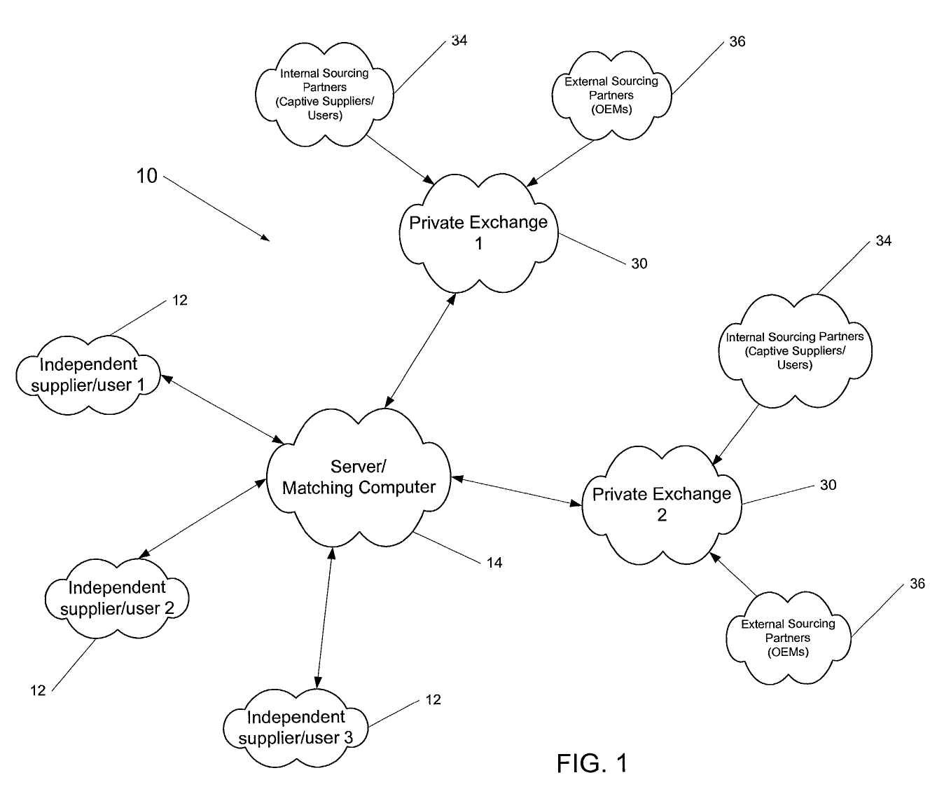

Referring first into FIG. 1, a multi-tier trading environment 10 includes a server 14 (operated by the administrator), private exchanges 30 which are schematically shown as including internal sourcing partners, for example suppliers/users 34 and OEMs 36, and independent supplies/users 12 which form part of a public exchange. The private exchange may be password-protected and is designed to maintain special trading relationships between its internal suppliers and users and issue, for example, internal reports and analyses which are not destined for public use. However, these arrangements have frequently proven to be less efficient than open sourcing arrangements, prompting entire industries, for example the automotive industry, to rely more on outside manufacturers and distributors for just-in-time delivery of components, even of customer-specific parts and assemblies.

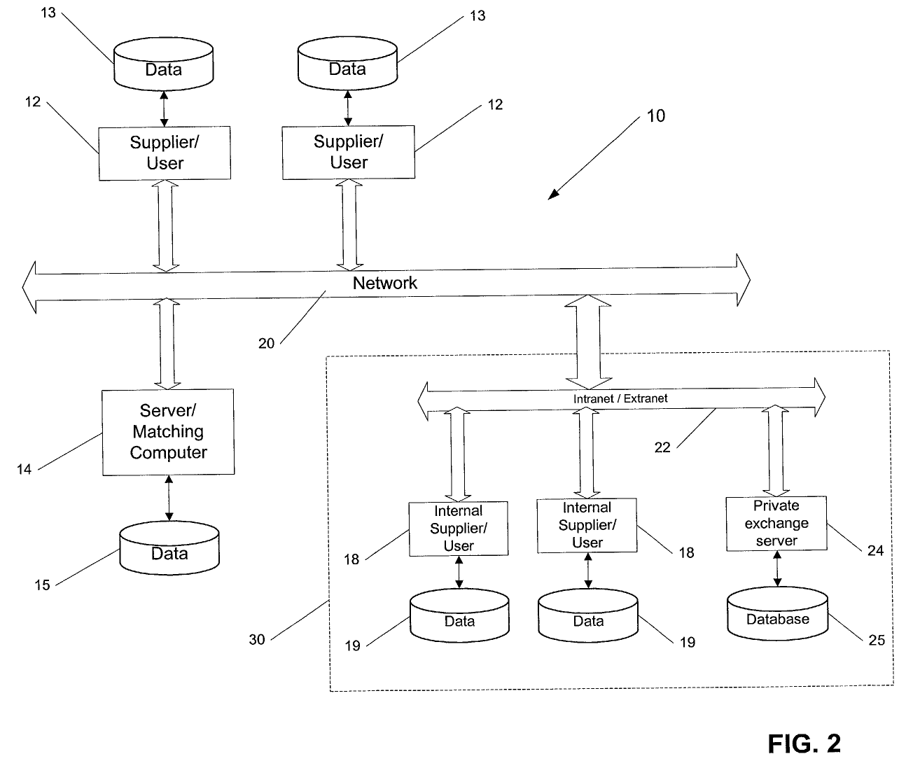

As shown in FIG. 2, the independent suppliers/users 12 may manage their own inventory and may store information about their inventory, such as parts designations, pricing and delivery schedules in proprietary databases 13. The suppliers 12 and the private exchange or exchanges 30 may be linked to the server 14 via network 20. The private exchange 30 may include internal suppliers/users 18 which may also manage their own inventory and store information about their inventory, such as parts designations, pricing and delivery schedules, in proprietary databases 19. The internal suppliers/users 18 may communicate with each other and with a private exchange server 24 over a network 22, such as an enterprise-wide intranet/extranet 22, which may be connected to the network 20 for communication with the server 14 and the suppliers/users 12 of the public exchange. The private exchange server 24, as it will be discussed below, may have the information about enterprise-wide product planning, including production schedules, delivery schedules and part numbers which may be stored on the server database 25 of the private exchange server 24. The private exchange server 24 may provide information about excess supply or demand within the private exchange 30, i.e., about a supply/demand imbalance between the internal suppliers/users 18 which are part of the private exchange 30. The private exchange server 24 may also provide information about an aggregate supply/demand imbalance, representing the sum total of supply and demand, of the private exchange 30 as a whole. This aggregate demand and supply information will be used by the server 14 to execute transactions between the various private and public exchanges.

The elements of the system 10 may include commercially available systems that have been arranged and modified to act as a system according to the invention, which allows a private exchange or a supplier/user of the public exchange to post RFQ's and excess inventory with the server 14, to execute transactions and optionally generate records of these transactions. The system 10 of FIG. 1 may employ the Internet to allow a supplier/user 12 and a private exchange 30 to access a central server, the depicted server 14, to log in to an account maintained by that server, and to employ the services relating to posting RFQ's and excess inventory. As will be discussed below, the trades themselves will be monitored, supervised and settled by the server 14.

For the depicted system 10, the client systems 12 and the private exchanges may include any suitable computer system, such as a PC workstation, a wireless communication device, or any other such device, equipped with a network client capable of accessing a network server and interacting with the server to exchange information with the server. In one embodiment, the network client is a web client, such as a web browser that can include the Netscape web browser, the Microsoft Internet Explorer web browser, the Lynx web browser, or a proprietary web browser, or web client that allows the user to exchange data with a web server, and ftp server, a gopher server, or some other type of network server. As mentioned above, the client 12, the private exchange 30 and the server 14 may rely on an unsecured communication path, such as the Internet, for accessing services. To add security to such a communication path, the client 12, the private exchange 30 and the server 14 may employ a security system, such as any of the conventional security systems that have been developed to provide to the remote user a secured channel for transmitting data over the Internet. One such system is the Netscape secured socket layer (SSL) security protocol (HTTPS) that provides to a remote user a trusted path between a conventional web browser program and a web server. Therefore, the client systems 12, the private exchange 30 and the server system 14 may have built in 128 bit or 40 bit SSL capability for establishing an SSL communication channel between the clients 12 and the server 14. The following activities may require SSL via HTTPS: listing parts, listing RFQs, bidding, responding to bids, changing any of the above, accessing membership information, changing membership information. Other security systems can be employed, such as those described in Bruce Schneir, Applied Cryptography (Addison-Wesley 1996). Alternatively, the systems may employ, at least in part, secure communication paths for transferring information between the server and the client. For purpose of illustration however, the systems described herein, including the system 10 depicted in FIGS. I and 2 will be understood to employ a public channel, such as an Internet connection through an ISP or any suitable connection, to connect the clients l2, the private exchange 30 and the server 14.

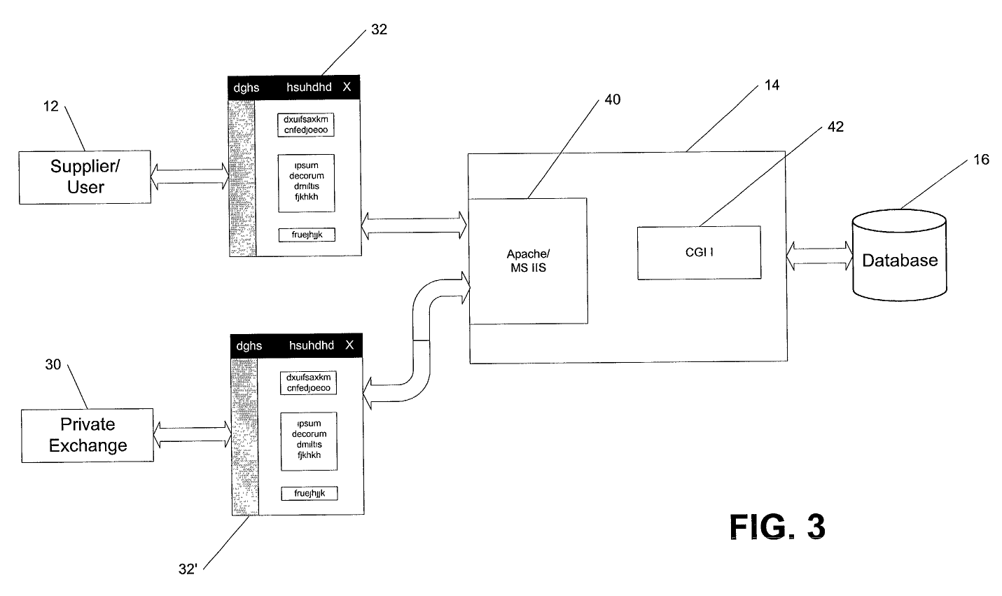

To facilitate exchange of information, a common standardized interface, such as the XML interface, is supported. Accordingly, as shown in FIG. 3, the server 14 may present the subscriber with an XML page 32 that acts as a user interface. This user interface may present to the client, which may be to the external supplier/user 12 or the private exchange 30, a set of controls for managing inventory information. For example, the user interface may provide to the client a control, typically a button on a web page, that directs the system to offers from suppliers which belong either to a public exchange or a private exchange, with the offers being managed by the server 14. The server 14 may be supported by a commercially available server platform, such as a Sun Sparc™ system running a version of the Unix operating system and running a server capable of connecting with or exchanging data with one of the client systems 12, 30. In the embodiment depicted in FIG. 3, the server 14 includes a web server 40, such as the Apache to Microsoft® IIS web server or any other suitable web server. The web server component 40 of the server 14 acts to listen for requests from the client 12, 30, and in response to such a request, resolves the request to identify a filename, script, dynamically generated data that may be associated with that request and to return the identified data to the requesting client 12, 30. The operation of the web server component of server 14 may be understood more fully from Laurie et al., Apache: The Definitive Guide, O'Reilly Press (1997). The server 14 may also include components that extend its operation to accomplish the matching of parties to conclude a transaction, as described herein, and the architecture of the server 14 may vary according to the application. For example, the web server may have built in extensions, typically referred to as modules, to allow the server 14 to perform operations that facilitate the operations of the multi-tier trading environment 10, or the web server may have access to a directory of executable files, each of which files may be employed for performing the operations, or parts of the operations, that implement the operations of the multi-tier trading environment 10. Thus it will be understood that the server 14 may act as a transaction server according to the invention that configures the work station hardware supporting the server 14 to act as a system according to the invention.

The server 14 may couple to a database 16 that stores information representative, for example, of the trading environment, including current parts listings, cross-references, RFQ listings, bids, responses to bids, membership information relating to both public and private exchange, as well as historical data, such as past parts availability and pricing trends. The depicted database 16 may comprise any suitable database system, including the commercially available Microsoft® Access™ database, and may be a local or distributed database system. The database 16 may be a relational database which provides a common view of the data to the users of the public and private exchanges. The design and development of database systems suitable for use with the system 10, follow from principles known in the art, including those described in McGovern et al., A Guide To Sybase and SQL Server, Addison-Wesley (1993). The database 16 may be supported by any suitable persistent data memory, such as a hard disk drive, RAID system, tape drive system, floppy diskette, or any other suitable system. The database 16 of the system 10 depicted in FIG. 3 is shown as being separate from the server station platform 14, however, it will be understood by those of ordinary skill in the art that in other embodiments the database 16 may be integrated into the server 14.

The web server 40 interacts with a common gateway interface (CGI) module 42 which can communicate web page content to and from a database 16 and has access to a set of executable files stored in a directory accessible to the web server 14. One such executable file may be a script that implements a procedure for displaying RFQs, excess inventory, price ranges, settlement dates, etc., as described below. The database manager 42 may be a Perl V script, a C language program or any other suitable program for providing a process that can manage, in response to information provided by the subscriber, database entries of the user.

The client PC's 12 depicted in FIG. 2 can be conventional personal computers having a CRT monitor, but may also be Web-TV's or intelligent LCD displays. The client PC's 12 may be provided with standard input/output devices, such as keyboards, mice, scanners or barcode readers, and printers (not shown).

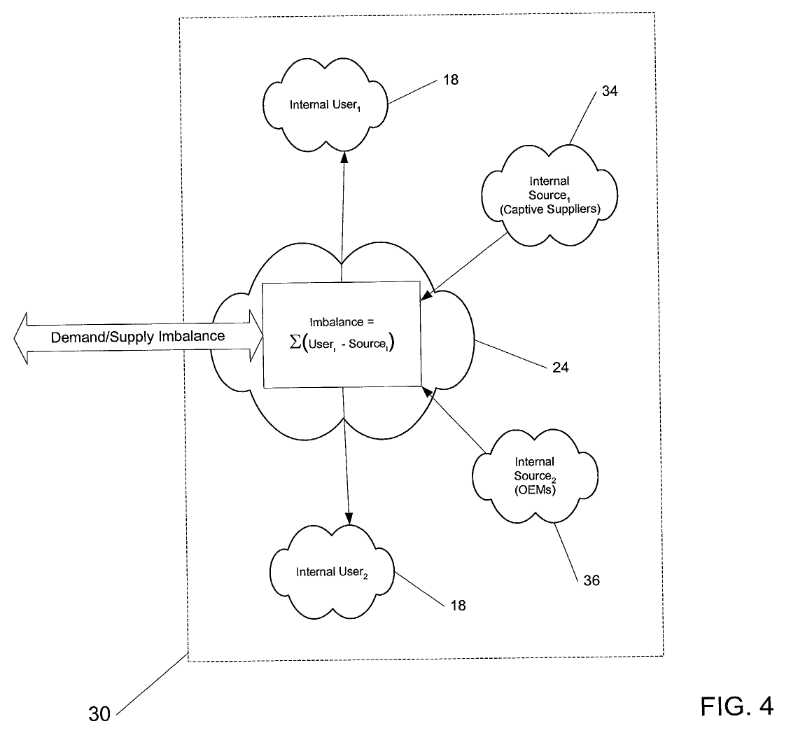

Referring now to FIG. 4, an aggregate imbalance in supply/demand in the private exchange 30 may occur because the internal users 18 have a greater need for material than can be supplied by the internal sources, such as the captive suppliers and OEMs 34, 36, respectively. An aggregate imbalance in the demand/supply of the private exchange will be reflected in the need of the private exchange to procure additional supplies or to sell excess inventory, which internal imbalance will then be indicated to the server 14. The server 14 will recognize the aggregate imbalance of the private exchange 30 as an imbalance of the private exchange 30 as a whole, rather than as need of the individual internal users 18 of the private exchange 30 to receive additional supplies and of the individual internal sources 34, 36 of the private exchange 30 to sell excess inventory.

The database 16 of the server 14 may also include a list with certain business rules. Business rules implement the policies and practices of an organization. For example, business rules can control the flow through the tasks of a business process. The next task is performed only when the rules that permit ending the previous task and those that determine that the next task should be entered have been satisfied. Business rules can also assist in decision-making and have a significant impact on decision support applications. For example, a rule system can determine whether or not users are permitted to purchase specific excess inventory from certain suppliers and/or whether or not suppliers are permitted to sell specific excess inventory to certain users. Vendors and/or suppliers may be blocked from such transactions on a onetime basis or permanently. Such a list can be compiled either for specific parts based, for example, on the part numbers, or for specific vendor-supplier combinations, for example, because of competitive constraints. For example, a supplier may have excess inventory of the video chips and also of microprocessors. While the supplier may be comfortable offering the video chips to Intel, which produces microprocessors, the same supplier may not want to offer the excess microprocessors to Intel. A rule system can also determine the creditworthiness of a client, i.e., the amount credit to extend to a customer.

The business rules may also include time limits by, for example, automatically posting to the public exchange certain parts after 15 days of availability internally or on the private exchange to ensure fair prices for excess inventory. The business rules may further include information about the interchangeability of components, including the part numbers, part types, available inventory and manufacturing capacity, and the geographic location of the trading parties.

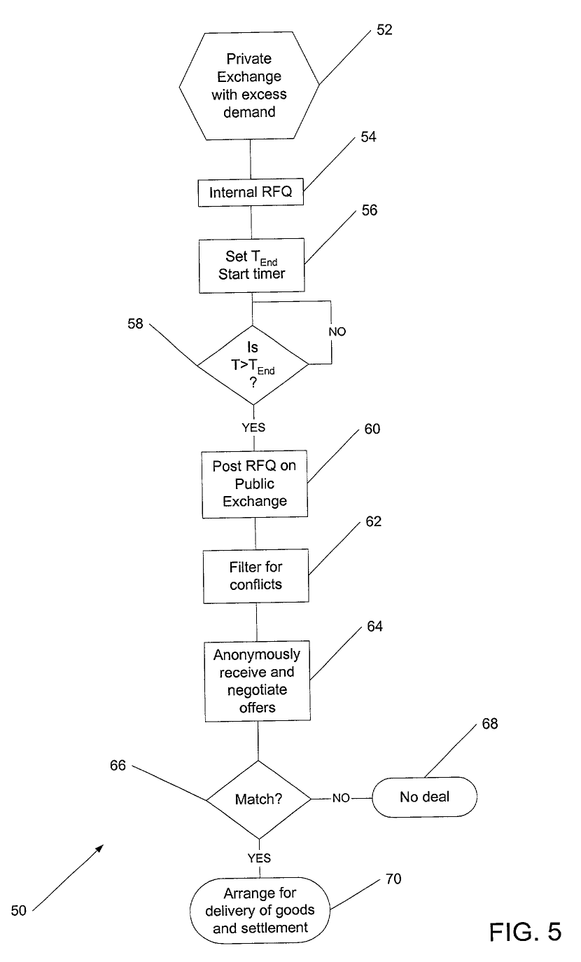

Referring now to FIG. 5, a flow diagram illustrates a process 50 according to the invention for satisfying excess demand of a private exchange 30 through purchases from public exchanges in the multi-tier trading environment 10. A private exchange 30 with excess demand 52 issues an internal RFQ to the internal users 18, step 54, and starts a timer after setting an end time T_{End}, step 56. The end time T_{End} indicates the end of the time period during which bids are solicited exclusively from internal suppliers 34, 36. An exemplary value for T_{End} may be 15 days or 1 month or any other time reasonable which would allow the private exchange to settle internal imbalances. When the elapsed time T exceeds the end time T_{End}, step 58, the RFQ is posted on the public exchange, step 60, by server 14 which also monitors and supervises the bidding and exchange process 50. The server 14 may execute an application program comparing the names of potential suppliers from the public exchange and registered with the server 14 with names authorized to bid for supplying the excess demand of the private exchange 30 in order to preventive potential conflicts, step 62. It should be noted, though, although the server 14 has the names of registered users and suppliers, the bidding process itself is anonymous, since the respective names of users and suppliers are not revealed to the other parties. The bidding process is monitored by the administrator (the server 14) and may proceed analogous to an auction where the asking price and the offer price are adjusted until an agreed price is negotiated. The administrator operating the server 14 may receive a commission for the trade which may depend on the finally negotiated price, for example, as a percentage of the negotiated price. Optionally, if the private exchange 30 gives its permission, the software running on the server 14 may allow the administrator to also monitor trading between the internal users 18 and the internal sources 34, 36 of the private exchange 30, so that the administrator operating the server 14 may also receive a commission for completed trades between the internal users and the internal sources in exchange for giving the private exchange access to the public exchange controlled by the server 14.

As mentioned above, the offers between the private exchange and suppliers are exchanged and negotiated with the parties remaining anonymous, step 64. If a private exchange is not willing to pay the price requested by a supplier 12 of the public exchange, step 66, then no deal is reached end the negotiations are terminated, step 68. Conversely, if the asking and offer price can be matched in step 66, then the server 14 or the administrator, respectively, arrange for the delivery of the purchased goods and for settlement of the charges, step 70, with the option to either reveal or not to reveal the identity of the respective parties.

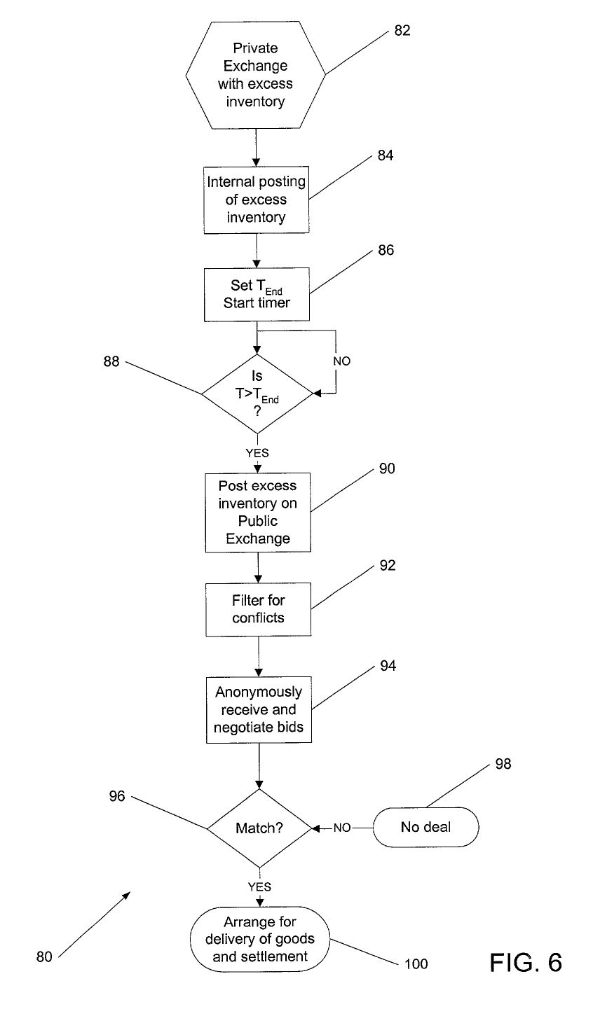

A situation where the private exchange has excess inventory is shown in FIG. 6. The flow diagram shown in FIG. 6 illustrates a process 80 according to the invention for disposing of excess inventory of a private exchange 30 through sales to public exchanges in the multi-tier trading environment 10. A private exchange 30 with excess inventory 82 posts the excess inventory to the internal users 18, step 84, and starts a timer after setting an end time T_{End}, step 56. The end time T_{End} indicates the end of the time period during which offer bids for the excess inventory are solicited exclusively from internal users 18. When the elapsed time T exceeds the end time T_{End}, step 88, the excess inventory is posted on the public exchange, step 90, by server 14 which also monitors and supervises the bidding and exchange process 80. As described above, potential conflicts between potential registered users from the public exchange and the private exchange 30 may be prevented by appropriately filtering the user and supplier data, step 92. Also, bids are received and negotiated without revealing the names of users and suppliers to the other parties, step 94. The asking price and the offer price are adjusted until an agreed price is negotiated, step 96.

As mentioned above, the offers between the public users and private exchange are exchanged and negotiated so that the parties remain anonymous and known only to the administrator or server 14, step 94. If a supplier 12 of the public exchange is not willing to pay the price requested by a private exchange, step 96, then no deal is reached end the negotiations are terminated, step 98. Conversely, if the asking and offer price can be matched in step 96, then the server 14 or the administrator, respectively, arrange for the delivery of the purchased goods and for settlement of the charges, step 100, with the option to either reveal or not to reveal the identity of the respective parties.

One way to ensure anonymity in the exchange network 10 is to use encryption and certificates, for example public-private key encryption using the RSA encryption algorithm. Other encryption standards, such as symmetric encryption according to the Data Encryption Standard (DES), the International Data Encryption Algorithm (IDEA), Blowfish™, and RC4 known in the art can also be applied.

The application program running on server 14 may also include agents that watch new parts listings and e-mail and/or instant messages interested members will run on their own computers. This arrangement increases reliability, scalability, and maintainability in the overall system, as compared to hosting all these features on the same computer.

In the past, private exchanges have essentially abstained from participating in the spot market. According to the invention, linking to the private exchange to the public exchange has the advantage of being able to report and query the state of the market. Since excess component transactions are negotiated in real time, the user can view a summary of recent transactions for the parts being bought or sold, similar to the way traders look at the price and volumes of stocks. To implement this feature, the private exchange can report all transactions on an anonymous basis to the public exchange so that an accurate ticker, closing price, and price/volume history can be reported to the entire market. Moreover, users of the private exchange have the advantage of being able to access to both the internal excess inventory and the public exchange which makes it much easier for a company to take advantage of activity in both exchanges. It should be noted that although all transactions in the public exchange and between the public exchange and the private exchanges are executed through the administrator or server 14, the administrator never actually takes possession of the goods being traded. Unlike traditional auction houses, the administrator also does not take goods on consignment; rather, the goods always stay with the respective supplier or private exchange that desires to sell excess inventory until a deal is concluded.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A system for identifying potential parties to a transaction, comprising:
a plurality of terminals enabling users to enter transaction data into the system,
a first subset of the users forming a part of at least one first exchange, with the users of each first exchange executing transactions within the first exchange to balance supply and demand within the first exchange, wherein a difference between the supply and demand within the first exchange defines a first aggregate supply/demand imbalance of the first exchange,
a second subset of the users different from the first subset of the users and forming a part of a second exchange, with a user of the second subset of the users having at least one of an excess supply and an excess demand to define a second individual supply/demand imbalance of the respective user,
a communication network having a server and linking with the server the terminals of at least one of the first exchanges and the second subset of users, the server polling the terminals to obtain the first aggregate and second individual supply/demand imbalances, and
the server applying at least one business rule to match the first aggregate and second individual supply/demand imbalances while preventing the first and second subset of users from obtaining the identity of the respective other users,
thereby identifying potential parties to a transaction.

2. The system according to claim 1, wherein the business rule is selected from the group consisting of part number, part type, part count, characteristic attributes of a party on the other side of the transaction, customizable time periods, and internal supply/demand of the first and second exchanges.

3. The system according to claim 2, wherein the characteristic attributes of a party are selected from the group consisting of geographic location of the party, name of the party, manufacturing capacity of the party and creditworthiness of the party.

4. The system according to claim 1, wherein the server includes a relational database capable of providing a common view of the transaction data to the users.

5. The system according to claim 1, further including encryption means to provide anonymity and authenticity of the users.

6. The system according to claim 4, wherein the relational database further includes a registry of the private exchanges and the users of the second subset.

7. The system according to claim 4, wherein the relational database further includes cross-references of components of interest to the parties.

8. The system according to claim 1, wherein the subset of the remote terminals forming a part of the at least one first exchange anonymously reports to the server transaction data between terminals of the subset of remote terminals of the first exchange.

9. A computer program residing on a computer-readable medium for identifying and matching potential parties to a transaction according to a plurality of business rules, comprising instructions for causing a computer to:
acquire from at least one first exchange having a plurality of users, the users forming a first set of users and executing transactions within the first exchange to balance supply and demand within the first exchange, a first aggregate supply/demand imbalance of the at least one first exchange, with the first aggregate supply/demand imbalance representing a difference in the supply and demand between the users within the first exchange;
acquire from a user being part of a second set of users different from the first set of users a second individual supply/demand imbalance of the respective user of the second set of users; and
compare and attempt to match — based on the business rules and while preventing the users from the first and second subset of users from obtaining the identity of the respective other users — the first aggregate and second individual supply/demand imbalances between the at least one first exchange and the second set of users, respectively,
thereby reducing an imbalance in a supply/demand between the parties.

10. A computer-implemented transaction method to generate a match between supply and demand within boundaries established by business rules, the method comprising:
first users forming a part of at least one first exchange and providing first transaction data,
the at least one first exchange forming from the first transaction data aggregate transaction data defining a first aggregate supply/demand imbalance of the at least one first exchange,
second users forming a part of a second exchange, a second user providing second transaction data which define a second individual supply/demand imbalance of the respective second user,
comparing the first and second supply/demand imbalances and — based on the business rules and while preventing the first and second users from obtaining the identity of the respective other users — matching the at least one first exchange and the second users of the second exchange based on the first and second supply/demand imbalances,
thereby reducing an imbalance in a supply/demand between the at least one first exchange and the second users.

11. The transaction method according to claim 10, wherein the business rules are selected from the group consisting of part number, part type, part count, characteristic attributes of a party on the other side of the transaction, customizable time periods, and internal supply/demand of the public and private exchanges.

12. The transaction method according to claim 11, wherein the characteristic attributes of a party are selected from the group consisting of geographic location of the party, name of the party, manufacturing capacity of the party and creditworthiness of the party.

13. The transaction method according to claim 10, wherein the first and second users are presented with a common representation of the transaction data.

14. A web site for matching supply and demand between parties to a transaction, with a first subset of the parties comprising a plurality of parties and forming a part of at least one first exchange, said first exchange providing first aggregate transaction data, and at least some of the remaining parties forming a part of a second exchange, with the parties of the second exchange providing second individual transaction data, the web site comprising:
a computer;
a database accessible by said computer;
a web page for receiving the first aggregate and second individual transaction data from the parties;
a program executing on said computer for comparing the received first aggregate transaction data and the second individual transaction data and — based on the business rules residing in the database and while preventing the first and second users from obtaining the identity of the respective other users — matching the at least one first exchange and the parties of the second exchange based on the first and second supply/demand imbalances,
thereby reducing an imbalance in a supply/demand between the at least one first exchange and the parties of the second exchange.

15. The web site according to claim 14, wherein the business rules are selected from the group consisting of part number, part type, part count, characteristic attributes of a party on the other side of the transaction, customizable time periods, and internal supply/demand of the first and second exchanges.

16. The web site according to claim 15, wherein the characteristic attributes of a party are selected from the group consisting of geographic location of the party, name of the party, manufacturing capacity of the party and creditworthiness of the party.

17. The web site according to claim 14, wherein the database is a relational database which provides a common view of the data to the parties.

18. The web site according to claim 17, wherein the web page is produced using an XML protocol.

19. The web site according to claim 14, further including encryption means to provide anonymity and authenticity of the parties.

20. The web site according to claim 17, wherein the database further includes a registry of the first exchanges and the parties of the second exchange.

21. The web site according to claim 15, wherein the relational database further includes cross-references of components of interest to the parties.

22. The web site according to claim 14, wherein the parties of the first subset of the parties report the transaction data between the parties of the first subset of the parties.
